(19) United States
(12) Patent Application Publication
(10) Pub. No.: US 2025/0184037 A1
(43) Pub. Date: Jun. 5, 2025

(54) DECODING SCHEME FOR SUBCARRIER-GROUPED OFDM SYSTEMS UTILIZING PER-SUBCARRIER SNR VALUES

(71) Applicant: Nokia Solutions and Networks Oy, Espoo (FI)

(72) Inventor: Di Che, Union, NJ (US)

(73) Assignee: Nokia Solutions and Networks Oy, Espoo (FI)

(21) Appl. No.: 18/524,257

(22) Filed: Nov. 30, 2023

(51) Int. Cl. H04L 1/00; H04L 5/00

(52) U.S. Cl. CPC H04L 1/0048; H04L 1/0054; H04L 5/0007

(57) ABSTRACT

A method and apparatus are provided for addressing problems in performing FEC decoding in OFDM communication systems, particularly problems associated with SNR fluctuations across the subcarrier frequency band. The disclosed decoding process is based on the use of per-subcarrier SNR values when performing data recovery in a subcarrier group sharing the same modulation format. That is, the bit-wise LLRs created for a given subcarrier are based upon that subcarrier's individual SNR, not an averaged (scalar) SNR used for all subcarriers within a given group.

### TECHNICAL FIELD

The present disclosure relates to data communications utilizing orthogonal frequency division multiplexing (OFDM), and is particularly directed to improving the decoding process by taking into consideration frequency-dependent transmission corruptions.

### BACKGROUND

Multicarrier modulation (MCM) techniques such as OFDM are known to maximize the data rate flexibility, as well as the spectral efficiency, in wireless and wireline systems. Passive optical networks (PONs) have been successful in providing broadband access to end users. While traditional PONs provide a fixed rate service to each end user, future PONs will require greater flexibility in order to handle diverse user requirements under various link qualities, besides the traditional goal of improving the network capacity. This makes MCM techniques such as OFDM a viable option for future PON systems.

Most communication channels, including those in PON architectures, suffer from a frequency-dependent (“colored”) response across the available bandwidth to support communication. In PON systems, frequency-dependent responses are typically the result of conditions such as frequency-selective fading due to fiber dispersion. Moreover, to take full advantage of a PON infrastructure, future PON transponders tend to push the capabilities of the hardware components (such as electrical-to-optical (E/O) modulators and photodiodes) towards their bandwidth limit, which also leads to an uneven frequency response across the usable bandwidth. As a result of the frequency-dependent response, the signal-to-noise ratio (SNR) is likely to fluctuate across the individual subcarriers and impact the ability to accurately recover transmitted data within a defined forward error correction (FEC) threshold (like a bit error rate (BER) threshold).

In various types of wireless or wireline MCM systems, a conventional way to deal with the frequency-dependent response of the channel is to utilize bit loading and power loading (BL and PL). Given a target FEC threshold, for each subcarrier with a specific SNR, BL finds a modulation format (without loss of generality, typically a uniform quadrature-amplitude modulation (QAM) format) whose performance is closest to the FEC threshold at the specific SNR. Because uniform QAM formats only provide integer rate granularity, the subcarriers that are assigned to the same modulation format are likely to still have different SNRs. The PL technique is then applied to adjust the signal power per subcarrier basis so as to equality the SNR across the group of subcarriers that are assigned to the same modulation format.

While useful in the above settings, PL may not be a suitable option for an optical system such as PON. First, optical transmitters typically have a peak power constraint (PPC) imposed by the finite modulation range of E/O converters. PL may enhance the peak-to-average power ratio (PAPR) of the signal, which results in signal power reduction under a fixed PPC. Moreover, the PL technique is used at the transmitter, which needs precise feedback with respect to the performance per subcarrier from the receiver to arrive at a proper power scaling factor per subcarrier. Such feedback increases the system complexity and latency. For a point-to-multipoint (P2MP) network like a PON, there are multiple end users at different locations who request data service asynchronously at random times. These considerations would require an even more sophisticated scheme to simultaneously collect the SNR information and perform a one-time PL.

Compared to BL and PL, an advanced technique to accommodate the frequency-dependent response is entropy loading (EL). Different from BL, EL uses the probabilistic constellation shaping (PCS) technique to adjust the rate per subcarrier in a continuous manner. In other words, instead of the integer granularity associated with BL, EL provides fractional entropy rates whose granularity can be arbitrarily small, depending on the system requirement. With this fine granularity, EL can find a modulation format exactly matching the specific SNR of each subcarrier without the need for an additional round of PL. Thus, EL provides much better flexibility than conventional BL, and is considered to be very promising for future flexible-rate PONs.

However, EL comes with a huge complexity inasmuch as each subcarrier requires an individual distribution matcher (DM) to generate symbols with a fractional entropy and a corresponding dematcher for demodulation. Moreover, EL also requires feedback information (i.e., SNR per subcarrier) from the receiver. To simplify the EL architecture, subcarriers with a similar SNR can be grouped into the same cluster to share a common PCS format, a technique referred to hereinafter a “subcarrier grouping” (SCG). SCG also alleviates the requirement of the precise feedback of per-subcarrier SNRs to the transmitter, since the overall SNR for each group (an “averaged” SNR among subcarriers) changes less frequently than the per-subcarrier values.

More generally, SCG is known to be a common technique that simplifies the modulation and demodulation processes for all kinds of OFDM systems. For example, BL can be thought of as a type of SCG, where subcarriers with the same order of QAM can be regarded as a group. A BL system can also fix a group size and force adjacent subcarriers to form a group with an identical modulation format. This has been implemented in various wireline and wireless standards, such as DOCSIS 3.1 and Wi-Fi 6.

In an OFDM system with SCG, the SNR fluctuation within each group cannot be ignored. Moreover, in a group including a large number of individual subcarriers, it is likely that the SNR fluctuations within the collection will be greater than the SNR fluctuations in a group that has only a few subcarriers. Therefore, when PL is not an option, an improved demodulation technique is needed for SCG-based OFDM systems to account for the presence of SNR fluctuations within each group of subcarriers.

### SUMMARY

Disclosed herein is an approach for overcoming the impact of SNR fluctuation on the operability of a network using SCG-based OFDM. The proposed approach is based on the use of individual, per-subcarrier SNR estimations to minimize the decoding penalty associated with fluctuations in SNR across the usable system bandwidth. The disclosed procedure is considered to be particularly well-suited for use in OFDM systems where PL is not a viable option.

The individual SNR estimates may be created a priori by sending probe signals across each subcarrier prior to initiating a communication session and creating an SNR-subcarrier mapping to be used thereafter. Alternatively, SNR estimates may be created on a per-frame basis (for example, subsequent to channel equalization). The latter approach may be preferable in situations where the channel's response is likely to be highly time variant and continually updating the SNR values by using probe signals may increase the system overhead, complexity, and latency due to the need for frequent feedback from the receiver to the transmitter.

In particular, and as will be discussed in detail below, a decoding process is proposed that is based upon the use of per-subcarrier SNR values when performing data recovery in a particular subcarrier group. That is, it is proposed that the bit-wise log-likelihood ratios (LLRs) created in the decoding process for a given subcarrier are based upon that subcarrier's individual SNR, not an “averaged” SNR associated with the group (or the overall system), as was common practice in the prior art.

The disclosed per-subcarrier SNR assisted decoding is applied to each group of subcarriers that share the same modulation format and exhibit different subcarrier SNR values (i.e., fluctuations in SNR within the subcarrier group). The use of per-subcarrier SNR values eliminates the need to attempt any type of transmitter-side compensation to mitigate the frequency-dependent response. In particular, the use of per-subcarrier SNR values eliminates the need to use PL at the transmitter. Consequently, a system with PPC, such as an optical transmitter, is able to accommodate SNR fluctuations without the power penalty due to the PL-induced peak-power enhancement.

The disclosed decoding scheme based on per-subcarrier SNR values is considered to be fully compatible with the most widely used bit-interleaved coded modulation (BICM) processes. That is, in accordance with the disclosed principles, the decoding associated with BICM takes into account the SNR per subcarrier instead of an overall system SNR when calculating the bit-wise LLR, an essential input of forward error correction (FEC) decoding.

When the disclosed per-subcarrier SNR technique is combined with entropy loading (i.e., subcarriers filled with rate-adaptive PCS symbols), it may be found to improve both hard decision (HD) and soft decision (SD) FEC decoding performance, as discussed in detail below.

An example embodiment relates in a first aspect to a method useful in decoding a FEC-encoded bitstream, comprising: obtaining an individual estimate of the SNR for each subcarrier used in a communication network employing multicarrier modulation (e.g., OFDM); creating a bit-wise, log-likelihood ratio (LLR) using the obtained individual estimate of each subcarrier's SNR; and performing forward error correcting (FEC) decoding of a received bitstream using the LLRs.

Similarly, the disclosure relates in a second aspect to an apparatus for use in the above-described decoding method, including circuitry for obtaining an estimate of the SNR for each subcarrier, circuitry for creating a bit-wise, log-likelihood ratio (LLR) using the obtained individual estimate of each subcarrier's SNR, and circuitry for performing forward error correcting (FEC) decoding of a received bitstream using the LLRs.

### BRIEF DESCRIPTION OF THE DRAWINGS

FIG. 1 is a simplified schematic drawing, illustrating a non-limiting example of network able to support SCG-based OFDM communication, in this case a point-to multipoint network such as a passive optical network (PON);

FIG. 2 is a simplified, functional block diagram of an OFDM transmitter of the kind that could be used in the implementation of the disclosed technique, for example in an OLT component of the network of FIG. 1;

FIG. 3 is a simplified, functional block diagram of an OFDM receiver implementing per-subcarrier SNR assisted decoding in accordance with the present disclosure, for example in an ONU component of the network of FIG. 1; and

FIG. 4 illustrates an alternative configuration of the OFDM receiver of FIG. 3 in this case utilizing per-subcarrier SNR estimates that are updated on a per-frame basis.

### DETAILED DESCRIPTION

An OFDM system transmits multiple data symbols at the same time over a plurality of subcarriers within a defined frequency band. OFDM systems may use “soft bit” information at the receiver for decoding the transmitted symbol. Log-likelihood ratio (LLR) values are commonly used as the soft bit information. For example, in communication systems utilizing FEC coding, LLR values are calculated for each information bit to be processed, and the LLR values are fed into a suitable decoder to recover the original information bits.

As will be described in detail below, this disclosure presents improvements in FEC decoding of OFDM symbols by incorporating per-subcarrier SNR estimates in the calculation of LLR values. This is in contrast to previous arrangements where the SNR was presumed to be essentially the same for each subcarrier in a given group. As mentioned above, this presumption has been found to be particularly problematic for groups that comprise a large number of individual subcarriers (since the larger the number of subcarriers in a particular group, the more likely it is that the individual SNR values will differ from an overall value shared by the group). Said another way, instead of presuming that the SNR is a scalar quantity, the disclosed process treats the SNR as a vector quantity, with each entry in the vector being the SNR estimate for a separate one of the individual subcarriers.

The disclosed premise of per-subcarrier SNR estimation and its use in SNR-assisted decoding is now described below in an example of a PON system that utilizes SCG-based OFDM to support data communication between OLTs and ONUs. The multiple access technique in a PON system may be time-division multiple access (TDMA) or frequency-division multiple access (FDMA). In TDMA, each end user utilizes all of the available subcarriers and time-shares the bandwidth resource with the other end users; in FDMA, each end user is assigned with a group (or multiple groups) of subcarriers, which is a fraction of the entire frequency band. Both TDMA and FDMA can use SCG to simplify the modulation/demodulation process, and without the loss of generality, the FDMA approach is used in the following to describe the SNR-assisting decoding process of the present disclosure. Further, it is to be understood that the following discussion related to implementing the use of per-subcarrier SNR is presented in the context of a “downstream” communication from an OLT to several ONUs in a PON. This is just only example; the disclosed technique may be used in upstream transmissions within a PON architecture as well and, additionally, may be used in multicarrier modulated communication systems in general (i.e., including wireless and wireline) where PL or other transmitter-side mitigation for SNR fluctuations is not a viable solution.

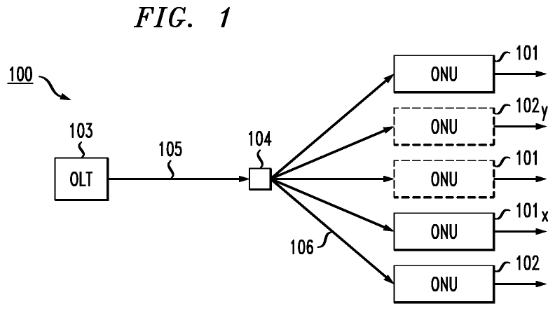

FIG. 1 illustrates a PON 100 that may utilize SCG-based OFDM for downstream data transmission. By way of illustration but not of limitation, an optical signal may be transmitted through fiber connections 105, 106. The network 100 comprises an optical line termination (OLT) 103 placed at the server provider's central office, and multiple optical network units (ONUs) 101, 102. A passive optical splitter 104 allows to distribute input received from the OLT 103 toward the connected ONUs 101, 102. The figure illustrates that a single optical fiber 105 serves multiple endpoints 101, 102, such that one optical signal is broadcast to every connected endpoint 101, 102. In FIG. 1, two different types of receivers 101, 102 are indicated as being present in the network 100. This is to illustrate that a P2MP network such as PON 100 may support a variety of different user types, with different rate demands and different levels of link quality.

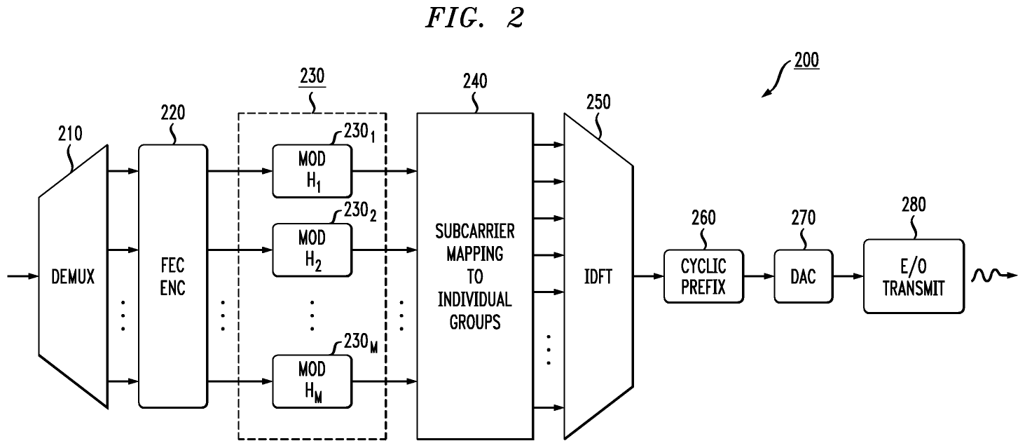

FIG. 2 is a highly simplified, functional block diagram of an OFDM transmitter 200 that may be used in, for example, PON 100 as shown in FIG. 1 that supports the use of subcarrier grouping (SCG) in performing OFDM modulation. It will be presumed that the number of available modulation formats is less than the total number of subcarriers (otherwise, subcarrier grouping would be irrelevant). Those subcarriers using the same modulation format are clustered together to define a subcarrier group. An extreme case is the use of a single group; namely, the case where all the subcarriers use an identical modulation format. In one example implementation, OFDM transmitter 200 may be located within OLT 103 of network 100.

OFDM transmitter 200 includes a demultiplexer 210 that functions to transform an incoming serial bit stream into a set of parallel (lower rate) bit streams. The set of parallel bit streams output from demultiplexer 210 thereafter goes through a FEC module 220 for FEC encoding, and is then applied as an input to a modulator 230. It is to be noted that for a TDMA system, FEC module 220 can be placed before demultiplexer 210 as a serial encoding process. As shown, modulator 230 comprises a set of individual modulation components 230i, with each modulation component 230i using a defined modulation scheme that is unique to that modulation component 230i. For example, in an EL transmitter, modulator 2301 may utilize a PCS-QAM format with an entropy of H₁, modulator 2302 may utilize a PCS-QAM format with an entropy of H₂, and so on, with a modulator 230_{M} using PCS-QAM format with an entropy of HM; these are only a few of a broad range of available modulation schemes.

The implementation of SCG is applied here as directing selected bit streams into a defined modulator component 230i. Each modulator component 230i functions in a well-known manner to map an applied set of input bits into a symbol associated with the particular constellation representation of the modulation scheme. The set of parallel symbols created by modulator 230 are then mapped onto the plurality of subcarriers, illustrated as a module 240 in OFDM transmitter 200, where a group (i.e., subset) of individual SCs is associated with each modulation format. In an example embodiment using FDMA, each ONU is assigned with one subcarrier group (or multiple groups), and the group indexes are recorded as preambles for the receiver-side processing per ONU.

The plurality of modulated subcarriers are thereafter passed through an inverse discrete Fourier transform (IDFT) module 250 that functions to convert the set of modulated subcarriers into a time-domain symbol stream. Cyclic prefixes may be added to at the beginning of each frame exiting IDFT 250 (shows as a cyclic prefix module 260 in FIG. 2), according to known practices in OFDM modulation. The digital output stream from module 260 is thereafter converted into an analog signal within digital-to-analog converter (DAC) 270 and transformed into the optical domain by an electrical-to-optical (E/O) converter 290 (for example, an optical intensity modulator) for transmission across the network.

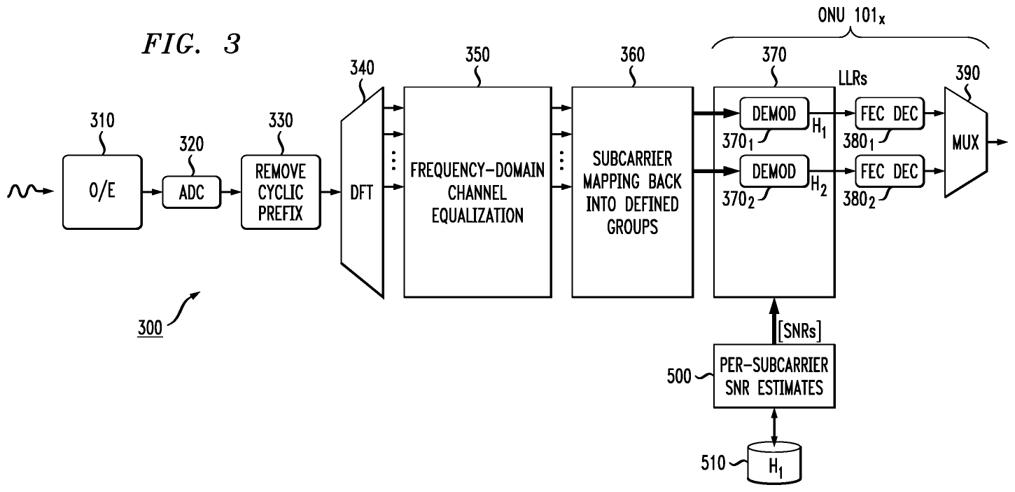

An OFDM receiver 300 is shown in FIG. 3, and essentially performs the inverse of the functions found in OFDM transmitter 200, where in accordance with the disclosed principles, individual per-subcarrier SNR values are used in the demodulation process. In one example implementation, OFDM receiver 300 may be located within an ONU 101 or 102, as shown in FIG. 1. For the purposes of the present discussion, it will be presumed that OFDM receiver 300 resides within an ONU 101x (as identified in FIG. 1).

With particular reference to FIG. 3, OFDM receiver 300 is shown as including an O/E converter 310 (e.g., a photodiode) which is used to transform the incoming optical signal into an electrical equivalent. The electrical output from O/E converter 310 is then passed through an analog-to-digital converter (ADC) 320 and the digital output is then applied as an input to a module 330 that removes any cyclic prefix that may have been added to the transmitted bitstream (such as by cyclic prefix module 260 of OFDM transmitter 200 of FIG. 2). With the prefix removed, a discrete Fourier transform (DFT) process is then applied (shows as module 340) to transform the time-based received stream into the frequency domain; that is, back into a set of modulated subcarriers. Channel equalization is then performed within a following module 350.

Note that in FDMA systems, each ONU only processes the group (or groups) of subcarriers that are assigned to it at the transmitter, and discards/ignores the other groups in the received transmission. Therefore, subsequent to the channel equalization within module 350, the individual signals are processed on a per-ONU basis. This is exemplified in the illustration of FIG. 3 by showing signals and elements associated with other ONUs (that is, other subcarrier groups not processed by ONU 101x) in phantom. Thus, as shown, OFDM receiver 300 will continue to process only the group(s) of subcarriers that are associated with ONU 101x. To that end, the set of equalized subcarriers exiting equalization module 350 are applied as individual inputs to a subcarrier mapping module 360, which is configured to recognize the particular subcarrier group(s) associated with ONU 101x. That is, module 360 retains the identity of the specific subcarriers assigned to each receiver (in the case of a PON, for example, the subcarriers associated to a particular ONU). The group(s) of subcarriers associated with ONU 101x are identified in FIG. 3 by the darker arrow outputs from module 360. The remaining subcarrier outputs are shown as thin lines in the diagram of FIG. 3, where it is to be understood that these subcarriers will be associated with one or more other OFDM receivers that are in communication with OFDM transmitter 200.

Continuing with the discussion of the processing of the subcarrier group(s) assigned to ONU 101x, the selected subcarriers from the mapping process are then provided as inputs to a demodulator 370 that is used to create the bit-wise LLRs from the symbols applied as inputs. In the particular example of FIG. 3, two different subcarrier groups are assigned to ONU 101x, which means that two different modulation elements 370₁ and 370₂ are required to properly demodulate the symbols present on the subcarriers. A first group of subcarriers is identified as having been processed in OFDM transmitter 200 using the first modulation format (i.e., PCS-QAM with an entropy of H₁). A second group of subcarriers is identified as having been processed with the second modulation format (e.g., PCS-QAM with entropy of H₂). Thus, demodulation elements 370₁ and 370₂ are configured to utilize these same two modulation formats, respectively.

In accordance with the principles of the present disclosure, OFDM receiver 300 as shown in FIG. 3 further comprises a per-subcarrier SNR estimation module 500 to provide an individual estimation of the signal-to-noise ratio for each subcarrier frequency being processed by OFDM receiver 300. As shown, the per-carrier SNR estimations are also applied as an input to demodulator 370. The estimation may be based on a priori knowledge obtained by sending probe signals through the network to acquire an SNR map across the complete set of subcarriers. Alternatively the per-subcarrier SNR values may be created (estimated) on a “per frame” basis after channel equalization. The latter approach updates the SNR estimation more frequently and may improve the decoding performance when the channel is known to be time variant. The particular configuration as shown in FIG. 3 illustrates the a priori implementation, where a database 510 maintains a mapping of SNR values for each individual subcarrier SC₁-SC_{N}.

The individual per-carrier SNR values stored within module 500 are applied as inputs to demodulator 370 in a manner such that the bit-wise LLRs calculated for each individual subcarrier are based on its unique SNR estimate. Recall that this was previously described as using a vector of individual SNR values instead of a prior art scalar value. It is contemplated that SNR estimation module 500 may be networked element that is shared by several individual receivers. In the example of FIG. 3, a first set of per-subcarrier SNRs for the subcarrier group associated with demodulation element 370₁ are applied as inputs to element 370₁; similarly, per-subcarriers SNR estimations for the remaining group of subcarriers are applied as an input to demodulation element 370₂.

Following demodulation, the LLRs of each subcarrier within the two groups are sent to a corresponding FEC decoder 380 for decoding. For a TDMA system, the LLR streams can be converted from a set of parallel streams into a continuous serial stream within a multiplexer 390, as shown in FIG. 3, and the FEC decoding can be processed in a serial manner.

Backtracking somewhat to a more detailed discussion of the demodulation process as improved by the use of the disclosed per-subcarrier SNR estimates, the following more specifically describes the symbol-to-bit demapping that takes place during demodulation. A set of symbols are directed as parallel inputs into a demodulator component 42i, which functions to map the received symbol r into an associated length-m bit sequence b=bₘ₋₁bₘ₋₂ . . . b₀ associated with a constellation symbol c=c(b). In this case, the LLR of the j^{th} bit of a received symbol r is defined as:

$$L L {R}_{j} = log [ \frac{P ( {b}_{j} = 0 \vert r )}{P ( {b}_{j} = 1 \vert r )} ] = log [ \frac{p ( r \vert {b}_{j} = 0 )}{p ( r \vert {b}_{j} = 1 )} ] ,$$

where P indicates the probability and p is the probability density function (pdf) of the j^{th} bit. If the noise of the received symbols follows a Gaussian distribution with variance σ², p may be expressed as:

$$p ( r \vert {b}_{j} = i ) = {\sum }_{b : {b}_{j} = i} \frac{p ( c ( b ) )}{2 π {σ}^{2}} exp ( - \frac{{‖ r - c ( b ) ‖}^{2}}{2 {σ}^{2}} ) .$$

where p(c(b)) is the a priori probability of a constellation point c(b). It is to be noted that the disclosed technique can be generalized to consider non-Gaussian noise distributions.

It is known that the estimation of the noise variance σ² (that is, the SNR) is a critical element to ensure a proper calculation of the LLR. While the prior art considers σ² to be a scalar value for all subcarriers within a defined group, the disclosed technique replaces this presumption by estimating the SNR for each independent, individual subcarrier. Thus, each subcarrier x has its own estimated noise variance σ_{sc_x}² which is thereafter used in generating the LLRs for that particular subcarrier. Said another way, SNR module 50 presents a vector of individual SNR values to each demodulator component 42i. Thus, the actual probability distribution function used to create the LLRs of the disclosed arrangement is defined as follows:

$$p ( r \vert {b}_{j} = i ) = {\sum }_{b : {b}_{j} = i} \frac{p ( c ( b ) )}{2 π {σ}_{sc \_ x}^{2}} exp ( - \frac{{‖ r - c ( b ) ‖}^{2}}{2 {σ}_{sc \_ x}^{2}} ) .$$

The use of per-subcarrier SNR estimates may have little influence on decoding performance when the channel response is flat (that is, when there is little or no fluctuation in SNR among a defined group of subcarriers, which is a common case when the conventional PL is applied at the transmitter). However, the disclosed technique of using individual SNR estimates is considered to significantly improve FEC decoding under a frequency-dependent channel response when there is a large disparity of σ² among the individual subcarriers.

The proposed SNR-assisted decoding in accordance with the principles of the present disclosure may be used to improve the performance of either HD FEC decoding or SD FEC decoding. For HD FEC, the LLRs output from the demodulator are first converted to bits using the following:

$$\{ \begin{matrix}b = 0 & if LLR > 0 \\ b = 1 & if LLR < 0\end{matrix}$$

and then sent to the FEC decoder. Note that the LLR-based HD is especially helpful for EL systems with PCS symbols. Different from a uniform QAM format which has fixed hard-decision boundaries among constellation points, a PCS format has uneven decision boundaries determined by the different probabilities of individual constellation points. The HD based on LLRs automatically optimizes the decision boundaries for a particular PCS format (because the LLR calculation takes into account the a priori probability of each constellation point), and consequently, a more accurate LLR calculated by the SNR per subcarrier is considered to improve HD performance. Such improvement on HD performance is unique to EL systems, and is not relevant to a BL system, since the HD boundaries for uniform QAM constellations stay the same with different noise variances (i.e., SNR). In other words, prior BL systems do not have the capability to optimize the HD per subcarrier based on the LLRs.

For SD FEC, the LLRs are directly sent to the FEC decoder. If the receiver performs turbo equalization which needs to update the LLRs by multiple iterations between equalization and FEC decoding, the SNR-assisted decoding may be applied in every iteration. In this case, the per-subcarrier SNR may also be updated after the equalization of each iteration. Both BL and EL systems can benefit from the SNR-assisted decoding when SD-FEC is applied.

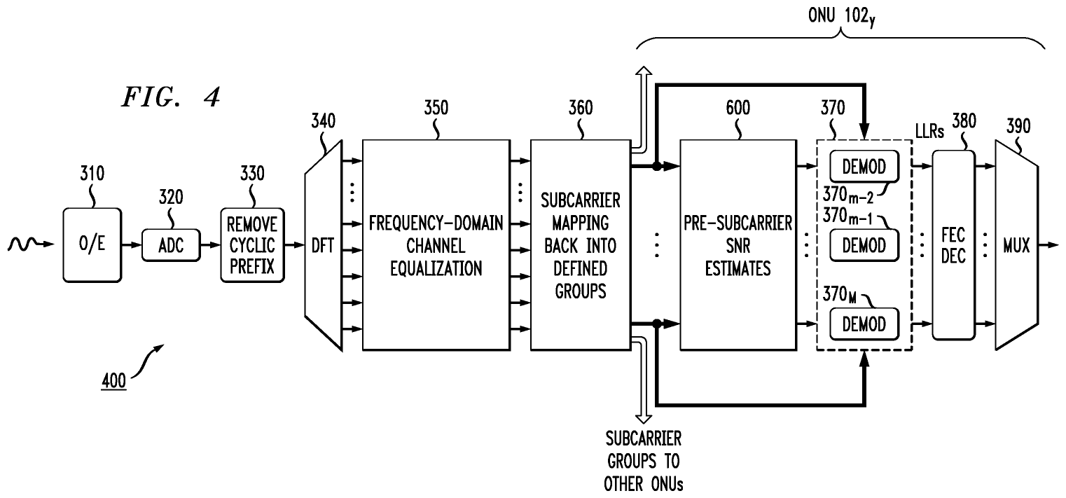

FIG. 4 illustrates a configuration of another embodiment of the disclosed OFDM receiver, here designated as OFDM receiver 400, which is associated with a different ONU (illustrated as ONU 102y in FIGS. 1 and 4). In comparison to OFDM receiver 300 of FIG. 3, the difference lies in the process used for obtaining the individual per-carrier SNR estimates. The initial modules used in the process up to and including subcarrier mapping are essentially the same as those described above and thus carry the same reference numerals as shown in FIG. 3. These initial modules include O/E converter 310, ADC 320, cyclic prefix removal module 330, DFT module 340, channel equalization module 350, and subcarrier mapping module 360.

The remaining elements as shown in FIG. 4 are associated with only those subcarrier group(s) associated with ONU 102y. In this example, those subcarriers in groups not associated with ONU 102y are shown as being directed away from the principal signal flow direction. The subcarriers within groups that are mapped to ONU 102y are illustrated by the darker arrows appearing at the output of subcarrier mapping module 360.

As mentioned above, one example process for obtaining per-subcarrier SNR estimates is to utilize the channel-equalized values to create the estimates in real time. OFDM receiver 400 is shown as including an SNR estimation module 600 as positioned in the signal path between the output of channel equalization module 360 and the input to demodulator 370. In this example, it is presumed that three separate groups of subcarriers have been mapped to ONU 102y and that three individual demodulation elements 370_{M}, 370_{M-1}, and 370_{M-2} are included. These demodulation elements may be associated with the particular modulation formats found in elements 230_{M}, 230_{M-1}, and 230_{M-2}, respectively, as shown in FIG. 2.

In this case, the subcarrier groups associated with ONU 102y are shown as thereafter provided as inputs to both SNR estimation module 600 and demodulator 370. SNR estimation module 600 is configured to provide frame-based updates to the per-subcarrier SNR estimates. It may be preferable in situations where a channel's response is likely to be highly time variant to continually update the SNR values to increase the accuracy of data recovery. The SNR estimates generated by module 600 are shown as also applied as inputs to demodulator 370, which uses these SNR values to arrive at the bit-wise LLRs for each presented symbol, in the manner described above. The following FEC DEC (and possible multiplexing) steps proceed within modules 380 and 390 as discussed above as well.

Summarizing, the proposed technique is considered to be applicable to all types of systems that involve OFDM, including but not limited to DSL, HFC and wireless systems (e.g., WiFI and 5G/6G cellular). Additionally, since passive optical network (PON) access architectures are considering flexible rate services using OFDM and BL/EL, the disclosed technique may be implemented in the optical domain as well. Inasmuch as SCG has been included in various standards (such as DOCSIS 3.1 and WiFi-6), the use of SNR-assisted decoding on a subcarrier basis is considered to be a straightforward improvement.

While methods and systems have been described herein with reference to certain implementations, it will be understood by those skilled in the art that various changes may be made and equivalents may be substituted without departing from the scope of the present method and/or system. Therefore, it is intended that the present method and/or system not be limited to the particular implementations disclosed, but that the present method and/or system includes all implementations falling within the scope of the appending claims.

What is claimed is:

1. A method, comprising:
obtaining an individual estimate of a signal-to-noise ratio (SNR) for each subcarrier used in a multicarrier modulated communication network;
at a multicarrier receiver, creating a bit-wise log-likelihood ratio (LLR) of each received symbol using the obtained individual estimate of each subcarrier's SNR; and
performing forward error correcting (FEC) decoding of a received bitstream using the created bit-wise LLRs.

2. The method of claim 1, wherein for creating a bit-wise LLR for each subcarrier the following relation is used:
$$L L {R}_{j} = log [ \frac{P ( {b}_{j} = 0 \vert r )}{P ( {b}_{j} = 1 \vert r )} ] = log [ \frac{p ( r \vert {b}_{j} = 0 )}{p ( r \vert {b}_{j} = 1 )} ] ,$$
where P defines a probability for a j-th bit and p defines a probability density function (pdf) of the j-th bit, and p may be expressed as:
$$p ( r \vert {b}_{j} = i ) = {\sum }_{b : {b}_{j} = i} \frac{p ( c ( b ) )}{2 π {σ}_{sc \_ x}^{2}} exp ( - \frac{{‖ r - c ( b ) ‖}^{2}}{2 {σ}_{sc \_ x}^{2}} ) .$$
and σ_{sc_x}² is based on a per-subcarrier SNR estimated for a subcarrier x.

3. The method of claim 1, wherein the method is performed in a passive optical network.

4. The method of claim 1, wherein the multicarrier modulated communication network is an orthogonal frequency division multiplexing (OFDM) communication network.

5. The method of claim 4, including
identifying a set of modulation formats to be used in the OFDM communication network;
for each individual modulation format, identifying a unique set of subcarriers using that modulation format, clustering each set of identified subcarriers; and
defining each cluster of identified subcarriers as a subcarrier group and thereafter performing per-subcarrier SNR estimation for each individual subcarrier.

6. The method of claim 5, wherein entropy loading (EL) is used for identifying the set of modulation formats to be used.

7. The method of claim 1, wherein the step of performing FEC decoding uses a hard decision (HD) methodology.

8. Apparatus comprising:
circuitry configured for obtaining an individual estimate of a signal-to-noise ratio (SNR) for each subcarrier used in a multicarrier modulated communication network;
circuitry configured for creating a bit-wise log-likelihood ratio (LLR) for each received symbol using the obtained individual estimate of each subcarrier's SNR; and
circuitry configured for performing forward error correcting (FEC) decoding of a received bitstream using the per-subcarrier LLRs.

9. The apparatus of claim 8, further configured to create the bit-wise LLR for each subcarrier by the following relation:
$$LL {R}_{j} = log [ \frac{P ( {b}_{j} = 0 \vert r )}{P ( {b}_{j} = 1 \vert r )} ] = log [ \frac{p ( r \vert {b}_{j} = 0 )}{p ( r \vert {b}_{j} = 1 )} ] ,$$
where P defines a probability for a j-th bit and p defines a probability density function (pdf) of the j-th bit, and p may be expressed as:
$$p ( r \vert {b}_{j} = i ) = {\sum }_{b : {b}_{j} = i} \frac{p ( c ( b ) )}{2 π {σ}_{sc \_ x}^{2}} exp ( - \frac{{‖ r - c ( b ) ‖}^{2}}{2 {σ}_{sc \_ x}^{2}} ) .$$
and σ_{sc_x}² is based on a per-subcarrier SNR estimated for a subcarrier x.

10. The apparatus of claim 8, wherein the circuitry configured to perform FEC decoding is further configured to perform HD decoding, based upon a presumption of EL used in signal creation.
